(19) United States
(12) Patent Application Publication
(10) Pub. No.: US 2022/0278974 A1
(43) Pub. Date: Sep. 1, 2022

(54) SYSTEM, DEVICE AND METHODS FOR SECURE EXCHANGE OF TEXT MESSAGES

(71) Applicant: MYSTERY STORY TECHNOLOGY LTD., Lehavim (IL)

(72) Inventors: Yuval SHTENDEL, Lehavim (IL); Shmuel GAL, Kibbutz Bet Kama (IL); Alexey TSIRLIN, Beer Sheva (IL); Ronit SHTENDEL, Lehavim (IL)

(21) Appl. No.: 17/626,556

(22) PCT Filed: Jul. 7, 2020
(86) PCT No.: PCT/IL2020/050758

§ 371 Date: Jan. 12, 2022

Related U.S. Application Data
(60) Provisional application No. 62/874,053, filed on Jul. 15, 2019.

(51) Int. Cl. H04L 9/40; H04L 51/04

(52) U.S. Cl. CPC H04L 63/061; H04L 51/04; H04L 63/0428

(57) ABSTRACT

The present invention provides systems, devices and methods for secure exchange of text messages between two or more end devices, wherein the messages are protected along their transmission path and while they are on the end device.

### FIELD OF THE INVENTION

The invention relates to the field of text messages exchange, more specifically, the invention enables a secure exchange of text messages.

### BACKGROUND

Currently, there are various applications for secure exchange of text messages, such applications allow message exchange between two or more end devices with end to end encryption.

However, even though the end to end encryption mechanism provides protection against attacks on the messages along their transmission path from one end device to the other, it does not provide any protection against attacks (such as cyber attacks) on the messages while they are on the end device. As a result, an attacker that penetrates to an end device (such as smartphone, tablet, laptop, PC and the like) may have direct access to the messages (at their plain text format).

Also available there are applications and software solutions that intend to provide protection against penetration to such end devices, however, as these end devices are based on complex architectures and may contain numerous applications and software programs, it is very difficult (if at all possible) to provide sufficient long-lasting and effective protection against such penetration attacks.

There is a need in the art for systems, devices and methods that can allow secure exchange of text messages between two or more end devices, as well as provide protection against attacks (such as cyber-attacks) on the messages while they are on the end device.

### SUMMARY OF THE INVENTION

The present invention, in embodiments thereof, provides systems, devices and methods that can allow secure exchange of text messages between two or more end devices, as well as provide protection against attacks on the messages while they are on the end device.

In some embodiments, the present invention provides methods, devices, and systems that enable secure exchange of text messages over a communication network (such as, cellular network, internet network) between two or more end devices (such as, external screen) connected to communication units (such as, smartphones), wherein the messages on the end device are protected against attacks.

In some embodiments, there is provided a system for secure exchange of text messages between end devices, the system may include: two or more end devices (each may be connected to a separate communication unit, wherein the communication units have an access to a communication network). In some embodiments, the system may also include one or more servers with an internet access.

According to some embodiments, there is provided a device for secure exchange of text messages, the device may include one or more of: a display module, a text input module, a communication interface module (connected to an external communication unit via wire/wireless connection), a cryptographic module and one or more Central Processing Units (CPU) with ROM/WPM based code memory. In some embodiments the end device may further include a battery or any other suitable power source.

In some embodiments, there is provided a method for secure exchange of text messages, the method may include end to end message encryption. In some embodiments the end to end message encryption may include generating a new encryption key for every new communication session.

In some embodiments, the exchanged messages and the encryption key are stored only in volatile memory (such as RAM).

In some embodiments at the end of a communication session, the session encryption key and the exchanged messages within that session are permanently deleted from the end device, for example by applying a power cycle shutdown and/or overwrite the volatile memory with random data.

According to some embodiments, the disclosed methods, devices, and systems are advantageous over currently used methods, devices, and systems for message exchange, as they allow or have the ability to not only protect the messages along their transmission path from one end device to the other, but also protect the messages while they are on the end device.

According to some embodiments, there is provided a method for secure exchange of text messages between two or more end devices, the method may include one or more of the steps of: connecting and pairing an end device with a communication unit; starting of a communication session; secure exchanging of text messages; and terminating of the communication session.

In some embodiments, the end device(s) used with the method includes: a display module; a text input module; a communication interface module; a cryptographic module; and Central Processing Unit (CPU) having ROM/WPM based code memory.

In some embodiments the method may further include a step of registration.

In some embodiments, starting a communication session may include the steps of: creating a communication link between two or more communication units; and exchanging communication session encryption key between the participating end devices.

In some embodiments, connecting and pairing an end device to a communication unit may further include an authentication step.

In some embodiments, connecting and pairing an end device to a communication unit may further include verifying that the end device is authorised to connect to that specific communication unit.

In some embodiments, secure exchanging of text messages may include sending and/or receiving text messages.

In some embodiments, sending text messages may include writing/composing a message on the end device; encrypting the message on the end device; and sending the encrypted message to the participating end devices via an external communication unit.

In some embodiments, receiving text messages may include receiving the encrypted message by the participating end devices via their external communication units; decrypting the message (only when it is on the end device); displaying (and/or narrating) the decrypted message on the end devices.

In some embodiments terminating of a communication session may include: permanently deleting the session encryption key and the exchanged messages within that session from the end device; closing the communication link of the communication unit; and disconnecting the end device from the communication unit.

In some embodiments, terminating of the communication session is initiated from the end device.

In some embodiments, terminating of the communication session is initiated from the communication unit.

In some embodiments, terminating of the communication session is initiated by the end user.

In some embodiments, terminating of the communication session is initiated after the max session duration timer has expired.

In some embodiments, terminating of the communication session is initiated after the session inactive timer has expired.

In some embodiments, terminating of the communication session is initiated as a result of communication failure.

In some embodiments, terminating of the communication session is initiated by a command (distributed via the communication units).

According to some embodiments, there is provided a device for secure exchange of text messages, the device may include one or more of: a display module; a text input module; a communication interface module; a cryptographic module; and Central Processing Unit (CPU) with ROM/WPM based code memory.

In some embodiments, the device is capable of executing a method for secure exchange of text messages, the method may include: starting a communication session; sending and/or receiving a text message; and terminating the communication session.

In some embodiments, the device may further include a battery.

In some embodiments, the display module and/or the text input module are a touchscreen.

In some embodiments, the Central Processing Unit (CPU) executes its instructions directly from a Read Only Memory (ROM) or Write Protected Memory.

In some embodiments, the Central Processing Unit (CPU) may be divided to two or more separate Central Processing Units.

In some embodiments, the separate Central Processing Units may include: a display CPU, a cryptographic CPU, and a text input CPU.

In some embodiments, at least one of the Central Processing Units (CPU) may be configured to execute the instructions directly from a Read Only Memory (ROM) or Write Protected Memory.

In some embodiments, the display CPU may be internally connected to a communication interface module via unidirectional connection only (out of the communication interface module into the display CPU).

In some embodiments, the text input CPU may be internally connected to a communication interface module via unidirectional connection only (out of the text input CPU into the the communication interface module).

According to some embodiments, there is provided a system for secure exchange of text messages, the system may include: two or more end devices, each configured to be connected to a separate communication unit. In some embodiments, the device may include one or more of: a display module, a text input module, a communication interface module, a cryptographic module, Central Processing Unit (CPU) with ROM/WPM based code memory, said device may be capable of executing steps in a method for secure exchange of text messages. In some embodiments, the method for secure exchange of text messages may include: connecting and pairing an end device with a communication unit; starting a communication session; sending and/or receiving a text message; and terminating the communication session. In some embodiments, terminating of the communication session may include: permanently deleting the session encryption key and the exchanged messages within that session from the end device; closing the communication link of the communication unit; and disconnecting the end device from the communication unit.

In some embodiments, the system may further include one or more servers.

In some embodiments, the communication units may have an internet access.

In some embodiments, the communication unit may be selected from a smartphone, a tablet, a laptop, a PC, or any combination thereof.

In some embodiments, the communication unit may establish and terminate a communication link with other communication units and/or with server(s).

In some embodiments, the communication unit may include a dedicated application for communication link creation and termination.

In some embodiments, the communication units may be connected to the end devices using wired and/or wireless connection.

In some embodiments, the wired connection may be via USB.

In some embodiments, the wireless connection may be via Bluetooth.

Further embodiments, features, advantages and the full scope of applicability of the present invention will become apparent from the detailed description and drawings given hereinafter. However, it should be understood that the detailed description, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

Some embodiments of the invention are described herein with reference to the accompanying Figs. The description, together with the Figs. makes apparent to a person having ordinary skill in the art how some embodiments may be practiced. The Figs. are for the purpose of illustrative description and no attempt is made to show structural details of an embodiment in more detail than is necessary for a fundamental understanding of the invention. For the sake of clarity, some objects depicted in the Figs. are not to scale.

FIG. 1. Shows illustration of a block diagram of a system for secure exchange of text messages between end devices, according to some embodiments;

FIG. 2. Shows illustration of a block diagram of a device for secure exchange of text messages connected to an external communication unit, according to some embodiments;

FIG. 3. Shows illustration of a block diagram of a device for secure exchange of text messages connected to an external communication unit, according to some embodiments; and

FIG. 4. Shows illustration of steps in a method for secure exchange of text messages, according to some embodiments.

### DETAILED DESCRIPTION OF THE INVENTION

The present invention, in embodiments thereof, provides systems, devices and methods that can allow secure exchange of text message(s) between two or more end devices, as well as provide protection against attacks (such as cyber-attacks) on the messages while they are on the end device.

To facilitate understating, the following terms are defined:

As used herein, the term “volatile memory” refers to a memory that requires power to maintain the stored information, when the power is interrupted the stored data is lost.

As used herein, the term “plain text” refers to a text at its original format (before it has been encrypted).

As used herein, the term “communication session” refers to a state wherein two or more end devices securely exchange text messages. The state starts when a link between the end devices is created/established and ends when the link is terminated.

As used herein, the term “communication unit” refers to an external unit that is connected at one side to an end device and at the other side to the communication network, hence provides the end device connection to the communication network.

As used herein, the term “selected communication units” refers to the communication units which participate in a communication session.

As used herein, the term “max session duration” refers to the maximal allowed time period of a single communication session.

As used herein, the term “session inactive” refers to an idle time period within an ongoing communication session in which there is no incoming or outgoing message transfer.

As used herein, the term “Write Protected Memory” (WPM) refers to a memory that does not support any remote update to its content, in order to update the WPM content, one must have physical access to the end device, and manually change the hardware settings (for example by placing a jumper).

In some embodiments the terms “device” and “end device” can be interchangeably used.

According to some embodiments, there is provided a system for secure exchange of text messages between end devices, the system includes: two or more end devices, each connected to a separate communication unit, wherein the communication units have an access to a communication network; and optionally one or more servers with an internet access. Each possibility is a separate embodiment.

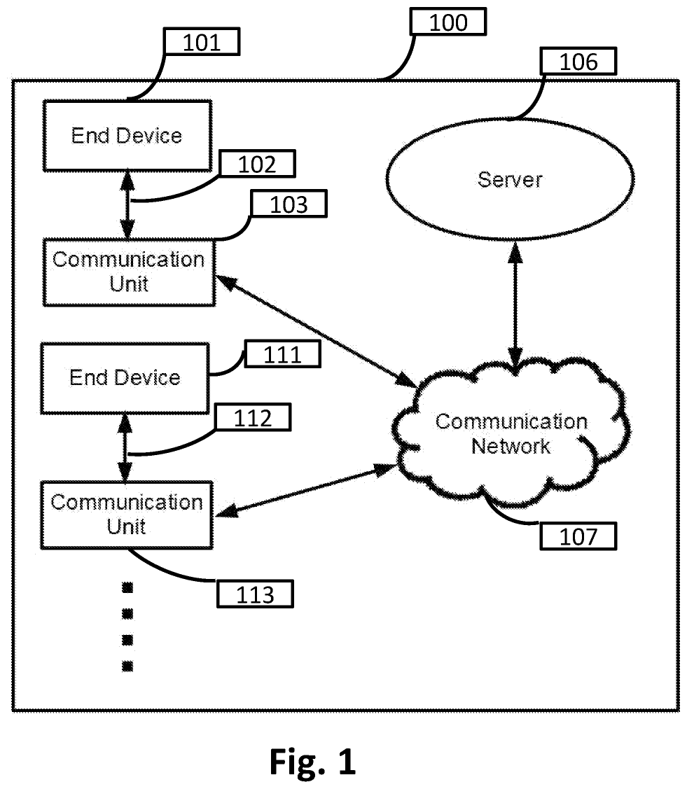

Reference is made to FIG. 1, which illustrates a block diagram of a system for secure exchange of text messages between end devices, according to some embodiments. As shown in FIG. 1, system 100 can include the following elements: end devices 101, 111 capable of executing a method for secure exchange of text messages; and communication units 103, 113. The system may further include server(s) 106.

In some embodiments, the communication units 103, 113, can each be for, example a smartphone, a tablet, a laptop, a PC, and the like. In some embodiments, the communication units may have an access to the communication network 107. In some embodiments, a communication unit may have the ability to create and terminate a communication link with other communication units and/or with server(s) 106, for example by using a dedicated application.

In some embodiments, the connection 102, 112 between an end device 101, 102 and the respective communication unit 103, 113 may be wired (such as, for example, by USB connection) or wireless (such as, for example, by Bluetooth connection).

In some embodiments, end devices 101, 111 are protected against attacks on their CPU firmware.

In some embodiments, the server(s) 106 may have access to the internet 107, or external network.

According to some embodiments, there is provided a device for secure exchange of text messages, the device may include one or more of: a display module, a text input module, a communication interface module (connected to an external communication unit via wire/wireless connection), a cryptographic module and one or more Central Processing Units (CPU) with ROM/WPM based code memory. In some embodiments the end device may further include a power supply, such as, a battery. Each possibility is a separate embodiment.

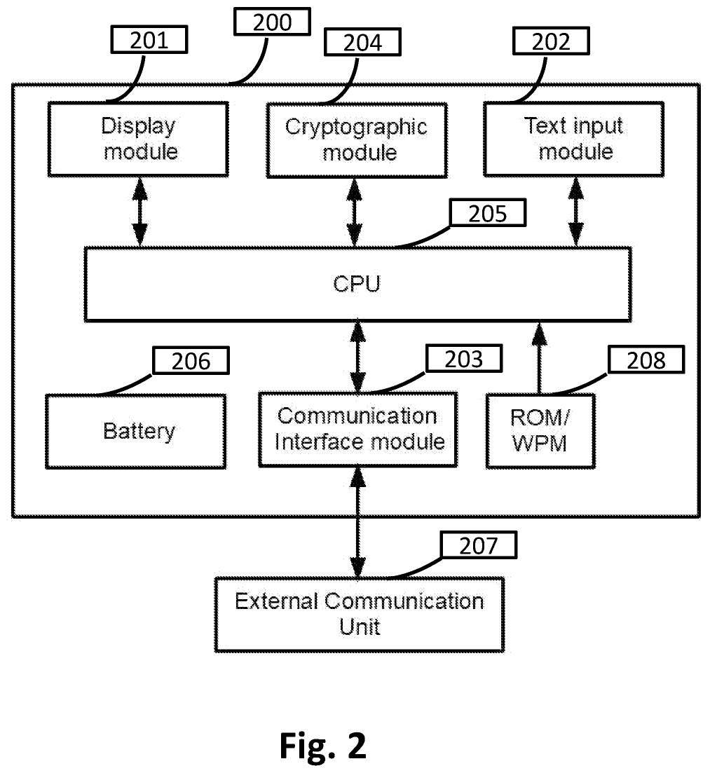

Reference is made to FIG. 2, which illustrates a block diagram of a device for secure exchange of text messages connected to an external communication unit, according to some embodiments. As shown in FIG. 2, device 200 may include the following elements and modules: a display module 201, a text input module 202, a communication interface module 203, a cryptographic module 204 and a Central Processing Unit 205 with ROM/WPM based code memory 208. In some embodiments the device may further include a battery 206.

In some embodiments, the display module 201 can be used by the CPU 205 to display the messages. In some embodiments the display module 201 can be, for example, an LCD screen, an OLED screen, a touch screen, and the like. In some embodiments the text input module 202 can be used by the CPU 205 to type in the message(s). In some embodiments the text input module 202 can be, for example, a keyboard. In some embodiments a touchscreen can serve as both display and text input modules.

In some embodiments, the cryptographic module 204, can be used by the CPU 205 for generating encryption keys, encrypting the outgoing messages and decrypting the incoming messages.

In some embodiments, a communication interface module 203 is used to connect the device 200 to an external communication unit 207. The connection may be wired connection (such as USB) or wireless connection (such as Bluetooth).

In some embodiments, the CPU 205 executes its instructions directly from a Read Only Memory (ROM) or Write Protected Memory 208. Such architecture prevents from potential attackers to tamper with the CPU firmware and gain access to the messages at their plain text format.

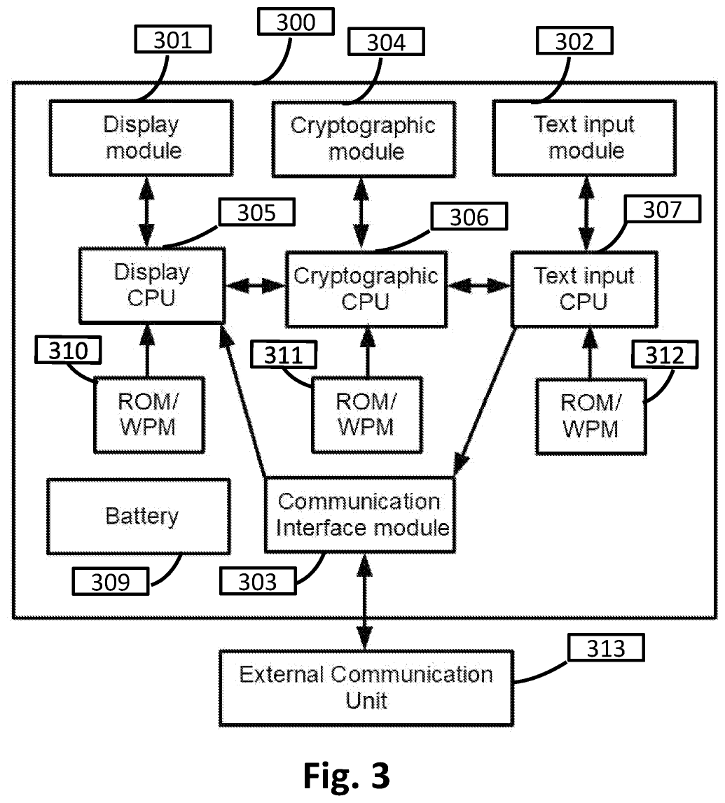

Reference is made to FIG. 3, which illustrates a block diagram of a device for secure exchange of text messages connected to an external communication unit, according to some embodiments. As shown in FIG. 3, device 300 may include the following elements and modules: a display module 301, a text input module 302, a communication interface module 303, a cryptographic module 304, a display Central Processing Unit 305 with ROM/WPM based code memory 310, a cryptographic Central Processing Unit 306 with ROM/WPM based code memory 311 and a text input Central Processing Unit 307 with ROM/WPM based code memory 312. In some embodiments the device may further include a battery 309.

In some embodiments the display module 301 can be used by the display Central Processing Unit 305 to display the messages. In some embodiments the display module 301 can be for example an LCD screen, an OLED screen, touch screen, and the like. In some embodiments the text input module 302 can be used by the text input Central Processing Unit 307 to type in the messages. In some embodiments the text input module 302 can be, for example, a keyboard.

In some embodiments, the cryptographic module 304, can be used by the cryptographic Central Processing Unit 306 for generating encryption keys, encrypting the outgoing messages and decrypting the incoming messages.

In some embodiments, a communication interface module 303 is used to connect the device 300 to an external communication unit 313. The connection may be wired connection (such as USB) or wireless connection (such as Bluetooth).

In some embodiments, the internal connection between the communication interface module 303 and the display CPU 305 is unidirectional only (out of the communication unit into the display CPU). In some embodiments, the internal connection between the communication interface module 303 and the text input CPU 307 is unidirectional only (out of the text input CPU into the communication interface module), such architecture provides better isolation between the display CPU 305 and the text input CPU 307, and helps to prevent unintentional leakage of data.

In some embodiments, at least one of CPUs (such as 305, 306, 307) executes the instructions directly from a Read Only Memory (ROM) or Write Protected Memory (such as, 310, 311, 312, respectively), such architecture prevents from potential attackers to tamper with the CPUs firmware and gain access to the decrypted messages.

According to some embodiments, there is provided a method for secure exchange of text messages, the method may include one or more of the steps of:

i. registration;

ii. connecting and pairing an end device with a communication unit;

iii. starting of communication session;

iv. securing exchange of text messages;

v. terminating communication session.

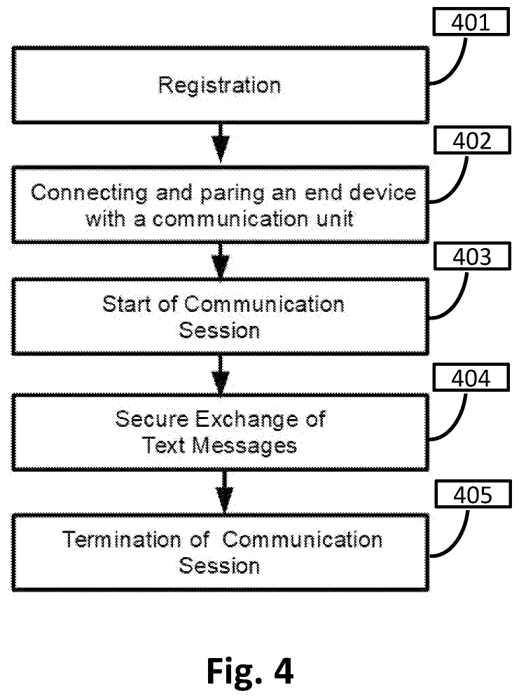

Reference is now made to FIG. 4, which illustrates steps in methods of the present disclosure, according to some embodiments. At step 401, registration of a user may be performed. Next, at step 402, connecting and pairing an end device with a communication unit may be performed. At step 403, a communication session may be started. At step 404, text messages can be securely exchanged between end devices participating in the communication session. At the last step 405, the communication session may be terminated.

The embodiments presented below provide an exemplary description of the various steps/functions supported/executed by the methods of the present disclosure, and their implementation in the suitable devices and systems.

### Registration

In some embodiments, registration step 401, may be performed after a dedicated application for creation and termination of a communication link is installed on the communicating unit (for example, a smartphone). In some embodiments, the registration step may include providing user details such as, for example, user name, address, phone number, etc. The registered phone number may be validated by means known in the art, for example, by sending a text message (such as SMS) to the phone.

In some embodiments, user details may further include serial number(s) of the user's end device(s).

In some embodiments, once the registration process is complete, the user can start communication sessions and securely exchange text messages with other registered users.

Connecting and Pairing an End Device with a Communication Unit.

In some embodiments, connecting and pairing an end device to a communication unit, may be completed only after successfully passing an authentication process (for example by entering a correct password, fingerprint, face recognition, and the like).

In some embodiments, the end device can be connected and paired with any available communication unit capable of creating and terminating a communication link with other communication units and/or with server(s).

In some embodiments, the end device can be limited to connect and pair only with specific communication units.

### Start of a Communication Session.

In some embodiments, starting of a communication session step 403, may include one or more of the sub steps of: creating a communication link between two or more communication units (“selected communication units”); exchanging encryption key of the communication session between the end devices which are connected to the selected communication units.

### Secure Exchange of Text Messages.

In some embodiments, secure exchange of text messages step 404, may include sending and/or receiving messages.

In some embodiments, sending a message may include one or more of the steps of: write a message on the end device; encrypt the message (while it is on the end device) using the encryption key of the communication session; send the encrypted message to the end devices which are part of the communication session (via the communication units).

In some embodiments, receiving a message may include one or more of the steps of: receive the encrypted message by the end device (via its communication unit); decrypt the message (when it is on the end device) using the encryption key of the communication session; display (and/or narrate) the decrypted message on the end device.

In some embodiments, all the messages are protected with end to end encryption along the entire transmission path (including on the communication units), and the only place that messages exist at their plain text format is on the end devices.

In some embodiments, the exchanged messages and the encryption key are stored only in volatile memory (such as RAM).

### Termination of a Communication Session.

In some embodiments, termination of a communication session step 405, may include: permanently deleting the encryption key of the communication session from the end device (for example by applying a power cycle and/or overwrite the volatile memory with random data); permanently deleting all the messages of the communication session from the end device; closing the communication link between the communication unit to the other selected communication units; and disconnecting the end device from the communication unit.

In some embodiments, termination of a communication session can be initiated from the end device.

In some embodiments, termination of a communication session can be initiated from the communication unit.

In some embodiments, termination of a communication session can be initiated by an end user.

In some embodiments, termination of a communication session can be initiated after the max session duration timer has expired.

In some embodiments, termination of a communication session can be initiated after the session inactive timer has expired.

In some embodiments, termination of a communication session can be initiated as a result of a communication failure.

In some embodiments, a command for termination of a communication session can be distributed (via the communication units) to end devices which were part of the communication session.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1.-39. (canceled)

40. A method for secure exchange of text message(s) between two or more end devices, the method comprising:
connecting and pairing an end device with a communication unit;
starting of a communication session;
secure exchanging of text message(s); and
terminating of the communication session.

41. The method of claim 40, wherein the method further comprises a step of registration.

42. The method of claim 40, wherein connecting and pairing an end device to a communication unit further comprises an authentication step and/or verification that the end device is authorised to connect to the communication unit.

43. The method of claim 40, wherein starting of a communication session comprises:
creating a communication link between two or more communication units; and
exchanging communication session encryption key between participating end devices.

44. The method of claim 40, wherein exchanging text message(s) comprises sending text messages, the sending comprising:
writing a message on the end device;
encrypting the message on the end device; and
sending the encrypted message to participating end devices via a communication unit.

45. The method of claim 40, wherein exchanging text message(s) comprises receiving text messages, the receiving comprises:
receiving the encrypted message by participating end devices via their external communication units;
decrypting the message, only when it is on the end device; and
displaying and/or narrating the decrypted message on the participating end devices.

46. The method of claim 40, wherein terminating of the communication session comprises:
permanently deleting the session encryption key and the exchanged messages within the communication session from the end device;
closing the communication link of the communication unit; and
disconnecting the end device from the communication unit.

47. The method of claim 40, wherein terminating of the communication session is initiated from or by one or more of: the end device, the communication unit, the end user, after a max session duration timer has expired, after a session inactive timer has expired, as a result of communication failure, by a command distributed via the communication units, or any combination thereof.

48. A device for secure exchange of text messages, the device comprising:
a display module;
a text input module;
a communication interface module;
a cryptographic module; and
a central processing unit (CPU) having ROM/WPM based code memory.

49. The device of claim 48, wherein the device is capable of executing a method for secure exchange of text messages, the method comprising:
connecting and pairing the device to a communication unit;
starting a communication session;
sending and/or receiving a text message; and
terminating the communication session.

50. The device of claim 48, wherein the Central Processing Unit (CPU) is configured to execute its instructions directly from the Read Only Memory (ROM) or Write Protected Memory (WPM).

51. The device of claim 48, wherein the Central Processing Unit (CPU) is divided to two or more separate Central Processing Units.

52. The device of claim 51, wherein the separate Central Processing Units comprises: a display CPU, a cryptographic CPU, and a text input CPU.

53. The device of claim 51, wherein at least one of the separate Central Processing Units (CPU) is configured to execute the instructions directly from a Read Only Memory (ROM) or Write Protected Memory.

54. The device of claim 52, wherein the display CPU is internally connected to a communication interface module via unidirectional connection only, out of the communication interface module into the display CPU; and/or wherein the text input CPU is internally connected to a communication interface module via unidirectional connection only, out of the text input CPU into the communication interface module.

55. A system for secure exchange of text messages, the system comprising:
two or more end devices, each configured to be connected to a separate communication unit, wherein the end devices comprise one or more of: a display module, a text input module, a communication interface module, a cryptographic module, a Central Processing Unit (CPU) comprising ROM/WPM based code memory;
wherein said end devices are capable of executing a method for secure exchange of text message.

56. The system of claim 55, wherein the system further comprises one or more servers and/or wherein the communication units have an access to a communication network.

57. The system of claim 55, wherein the communication unit is selected from a smartphone, a tablet, a laptop, a PC, or any combination thereof.

58. The system of claim 55, wherein the communication unit is capable of establishing and terminating a communication link with other communication units and/or with server(s).

59. The system of claim 55, wherein the communication unit comprises a dedicated application for communication link creation and termination and/or wherein the communication units are connected to the end devices using wired and/or wireless connection.
